(19) United States
(12) Patent Application Publication
(10) Pub. No.: US 2005/0099498 A1
(43) Pub. Date: May 12, 2005

(54) Digital video system-intelligent information management system

(76) Inventors: Ich-Kien Lao, Raleigh, NC (US); Albert J. Dalola, Cary, NC (US); William B. Silvernail, Raleigh, NC (US)

Correspondence Address: HUTCHISON & MASON PLLC, PO box 31686, RALEIGH, NC, 27612, US

(21) Appl. No.: 10/704,046

(22) Filed: Nov. 7, 2003

(51) Int. Cl. H04N 5/76; H04N 5/225

(52) U.S. Cl. 348/207.99; 386/117

(57) ABSTRACT

A digital video information management system for monitoring and managing a system of digital collection devices is disclosed. Information files are automatically transferred from such collection devices to the information management system. Digitally captured information is classified to assign information attributes which are used to categorize and establish management, storage, and retention characteristics. A unique file, filename, and attributes are created for each recorded event, allowing the information management system to manage each event efficiently. The information management system automates a process to transfer digital information to other users or network-connected devices. Transfer of digital information can be done on a scheduled basis, or in response to an information request, or upon instruction by an end user. Information transferred from digital collection devices at geographically dispersed sites to the information management system are synchronized or “rolled-forward” to a master or mirrored database. Information is erased or deleted from a digital collection device once the information has been transferred to the storage and retention system of the information management system. The status of any given digital collection device is automatically determined and configuration and software updates are downloaded to the device as required. A centralized time reference may be used to synchronize such digital recording devices.

### CROSS-REFERENCE TO PRIOR APPLICATIONS

This application claims the benefit of U.S. Provisional Application No. 60/379,686, filed on Nov. 11, 2002, and is incorporated herein by this reference.

### BACKGROUND OF THE INVENTION

A variety of vehicle-installed video systems have been developed that provide the ability to capture, record and store video and audio information. One such solution integrates a commercial magnetic tape recorder mounted in a vehicle trunk or within the vehicle interior compartment. The video and audio information is recorded to, and retained primarily on magnetic tape cartridges. Storage and retention of the video and audio information is done by inventory of the recorded magnetic tape cartridge in a secure facility until needed. Each magnetic tape cartridge usually contains several hours of recording and would contain multiple events sequentially recorded.

Mobile and vehicle-installed recording systems are used by law enforcement agencies, among others, to capture video and audio information related to law enforcement activities. Such activities include routing traffic stops, arrests, surveillance, and the like (each, an “event”). Recording such events allows law enforcement agencies to corroborate the recollections, and testimony where applicable, of law enforcement officers. By recording other information along with such audio and video data, it becomes possible to compile a cohesive set of facts related to an event. Such other information can include the date and time of day, speed data captured from a radar gun device, and data from the vehicle in which such a recording system is installed, such as the vehicles speed, ambient temperature, humidity, and the like.

Examples of conventional analog video camera systems are disclosed in U.S. Pat. No. 4,789,904 entitled “Vehicle mounted Surveillance and Videotaping System” by Peterson, U.S. Pat. No. 5,408,330 entitled “Video Incident Capture System” by Squicciarini and Elcom, and U.S. Pat. No. 6,028,528 entitled “Apparatus and Methods for Managing Transfers of Video Recording Media used for Surveillance from Vehicles” by Lorenzetti and Blanco. Each of these known prior art references disclose aspects of existing analog video tape recording systems and information management systems. Traditionally, the management of information gathered out in the field by analog video camera systems consisted of the mere retention of the physical video tapes, the transcription of the contents of such tapes, and the cataloging of such tapes and transcripts. With the introduction of vehicle-installed digital video recording systems, new methods of managing, storing and retaining of video and audio information are possible using an intelligent information management system.

It is recognized in the art that one primary problem with prior art systems is that they record information to removable magnetic media such as video tape cartridges. The use of removable magnetic media increases the difficulty of transferring the video and audio information to an information management system, and also makes the information vulnerable to defects and damage due to handling of the removable cartridges. In addition, the need to retain large quantities of tapes and transcriptions presents a formidable storage problem, and therefore encourages the destruction of the tapes and transcriptions either deliberately or inadvertently.

### SUMMARY OF THE INVENTION

The present invention discloses techniques associated with the capture, attribution, transfer, storage, retention, management and deletion of video and audio information that has been collected or recorded by a mobile digital recording device. The digital recording device is primarily associated with collecting and recording information including: video, audio and alternate information inputs. Utilizing the techniques exemplified by the present invention it is possible to develop intelligent information management systems for capturing, assigning attributes to, transferring, storing, retaining, and managing such digitally recorded information. The present invention further discloses techniques that allow an intelligent management system to manage a variety of digital recording devices in an automated fashion.

The present invention discloses methods whereby digitally captured information, usually typified by or consisting of video, audio, and/or alternate information data (e.g., radar gun data, Global Positioning System (GPS) coordinates, inputs received from other information systems, sensor indicators, vehicle computer, etc.) may be classified or attributed to assign information attributes which may be used to categorize and establish management, storage and retention characteristics of such digitally recorded information.

The present invention discloses methods for classifying or attributing such digitally recorded information both locally, at its point of creation (usually on the digital recording device), and/or later after the information has been transferred to an information management system. Specifically, it allows for unique attributes to be created and assigned for, and associated with, each such recorded event. The result of associating such unique attributes to each such event allows the information management system to manage each event individually. This method allows an end-user operator to make an initial determination of the classification of an event at the time of recording, while also allowing a subsequent end-user operator to modify the classification or attribute. If the classification is changed by a subsequent user of the event information, it is further contemplated that a record or event log is generated to provide a historical record of such modifications.

The present invention further allows for the effective deployment and management of storage equipment necessary to retain such digitally recorded information. A method is disclosed for a user of such information to establish and implement criteria for its retention and storage, to utilize event attributes and other classification information, and enable rules-based processes to store, retain, distribute, delete, and/or otherwise manage the information management system automatically.

The present invention discloses methods for applying attribute information or “bookmarking” that may be utilized to mark key events, chapters or transitions for immediate or rapid navigation to these key events during subsequent review or presentation. The present invention further allows the direct access to an individual frame or sequence of digitally captured video and audio information from the associated attribution information, and also allows a user to “jump” directly to a specific event that is captured within a larger information file. Utilizing the present invention provides a technique and methodology to perform this type of navigation. Bookmarks or timestamp references within an asset file may be created both during the time of event recording or subsequently after the information has been transferred to an information management system. Bookmarks and timestamps may be created both manually or by an automated action, sensor, input or other device. An example of the use of this method includes the ability to add a bookmark to a frame of an event upon the detection of the deployment of a vehicle airbag or crash sensor, thereby allowing the event to be easily located during subsequent playback or processing by an integrated information system.

The present invention discloses a method for associating a unique file, filename and attributes with each recorded event. This allows an end-user operator or an information management system to manage each event individually, thereby allowing an information management system to automatically locate and manage files based on such filenames and attributes.

The present invention discloses methods whereby an information management system may monitor an environment of connected devices (i.e., digital recording or collection devices such as a digital recording device, a camera, a microphone, and the like) and automate information management functions such as retention, archiving, storage, and the like. Methods are provided whereby it is possible to automate a process to transfer information files from digital collection device(s) to information management system(s) and add new digital information or files that are not already found on the information management system. A method is also provided whereby an information management system may automate a process to transfer information to other users or network-connected devices. Transfer of this information to other users may be done based on a scheduled transfer time or immediately based upon system rules or request for the information. Information transferred from a digital collection device to an information management system may be done at geographically dispersed sites and then synchronized or “rolled-forward” to a master, centralized or mirrored database. The information collected by an information management system may be “rolled-forward” on a selective basis. Either all of the information collected, or only a subset of such information, may be propagated to other information management systems based on defined system rules.

The present invention discloses a method whereby an information management system may automate a process to erase information from a digital collection device that has been safely transferred to the storage and retention system without intervention by an end-user operator. In order to ensure the accuracy of this automated process, the process provides a methodology to correlate the information on both an information management system and a digital recording device to determine if the process was successfully completed prior to erasing any information data. Upon completion of this process, the digital recording device is “ready” to record new events. The method disclosed also allows the transfer process to be completed on an incident-by incident basis thus enabling the digital recording device to be removed from its in-vehicle or non-mobile docking station in the middle of the transfer process while ensuring that the information previously transferred will be maintained by the information management system.

The present invention discloses a method whereby an information management system may automate a process to determine the status of a digital recording device and to download configuration and software updates to the device as required. The information management system disclosed is suitably enabled to inquire and monitor the status of one or more digital recording devices. If it is determined that a digital recording device connected to an information management system requires a software update, or that system synchronization is required, the information management system is enabled to automatically perform such tasks. Examples of such updates include downloading new system operating instructions, updating the system clock to the master system clock, or reconfiguring the digital recording device for a different end-user operator.

The present invention provides a method whereby upon connection of a digital recording device to an information management system (either by direct network wiring or wireless connection), the presence of the digital recording device is automatically discovered and the process of uploading recorded information is automatically initiated. Upon completion of the uploading process, the digital recording device will signal the end-user operator that the process has been completed.

The present invention provides a method whereby an information management system may automate a process to transfer information to other users or network-connected devices. Transfer of information to other users can be done based on a scheduled transfer time, classification or immediately based upon a request for the information. Since all information files do not have the same importance, and due to the fact that geographically dispersed information systems may be inter-connected by network connections of varying speed, it may not always be necessary to send all recorded events to other users or network-connected information management systems. The methods disclosed enables an information file to be sent to other users and/or information management systems when necessary, or when instructed to do so by a user or automated device.

The present invention discloses a method whereby an information management system may automate a process of assigning a given digital recording device to an end-user operator. Because of the need to maintain end-user-specific information within each digital recording device, it may be necessary for an information management system to track digital recording devices as they are docked and subsequently removed to return to use in the field. The method disclosed allows an end-user operator to ‘check-out’ a digital recording device whereby an information management system downloads end-user-specific information prior to undocking the digital recording device from the information management system. Examples of end-user-specific information may include the end-user's name, identification number, user preferences, department number, and the like. Upon return a digital recording device from field use, the method disclosed provides a ‘check-in’ process whereby recorded information is downloaded to the information management system and the digital recording device is prepared for assignment to a subsequent end-user operator.

The present invention discloses a method whereby an information management system may automate a process of managing installed software functions and enabling the activation of certain applications and/or functions by means of a license management function. The information management system disclosed is enabled to track the number of authorized licenses that are available to enable certain functions on one or more digital recording devices. For example, a digital recording device may be carried in each vehicle operated by such a law enforcement agency, but only a subset of such vehicles are routinely used to patrol for speeding motorists. Therefore, such a law enforcement agency may opt to minimize its software license fees by procuring licenses that enable its digital recording devices to communicate with a radar gun for only a subset of its digital recording devices. In the event that a given digital recording device does not contain a license for such a feature, the information management system can assign a “floating” license to such a digital recording device, or can procure additional licenses in real time. This method can be used to prevent the unauthorized use of licensed features.

The present invention provides a method whereby an information management system may distribute event information by means of streaming recorded information files over both wired and wireless networks. It is possible that certain information files may be required immediately and sometimes over networks of varying bandwidth and speed. The information management system disclosed is enabled to distribute such information files to different end-users utilizing industry standard or proprietary streaming means. An example of the utility of this method is evident when a stream of information is delivered from the information management system to a user in the field utilizing a wireless network. The streamed information may be depicting an event that is occurring in real-time and is used by a team of law enforcement officials to coordinate their response to the unfolding event. It is possible that certain members of the team, for instance an officer in the field, would be unable to receive a full resolution video and audio stream. Therefore, the information management system is suitably enabled to stream the desired information at a lower resolution that matches the equipment of each receiving team member.

The present invention discloses a method whereby an information management system may exchange information files in different formats based on the requirements of different application or processes, such formats including without industry standard formats such as XML (Extensible Markup Language), HTML (HyperText Markup Language), Justice XML, as well as proprietary formats.

The present invention discloses a method whereby a centralized time-reference may be used to synchronize other equipment attached to an information management system such as a digital recording device. This synchronization is necessary to ensure that multiple digital recording devices are time-synchronized with each other as well as the information management system, and to ensure that each internal clock is accurate. This ensures that recorded event information is synchronized with a central time source contained within the information management system.

The present invention discloses a method whereby the centralized time-reference of an intelligent information management system may utilize one or more external time-reference sources such as the Time Service Department of the United States Naval Observatory, the National Institute of Standards and Technology, a GPS signal, and the like.

The present invention discloses a method whereby information may be transferred to an information management system from one or more digital collection devices based on pre-defined rules. One example of a pre-defined rule used in this method includes giving priority to the uploading of certain information over other information, such as uploading video information before the accompanying audio.

The present invention discloses a method whereby the information management system may utilize incident classification codes as attributes to uniquely categorize recorded events. One example of such an incident classification code that may be used to categorize recorded events are public safety “10 Codes” (ex. 10-4).

The present invention discloses a method whereby an information management system is enabled to analyze the recording of an event and extract a still photograph. In one embodiment of the present invention, the still photograph extracted may be that of a vehicle license plate, and to further analyze the content of such photograph using optical character recognition techniques to extract the actual characters of such license plate. In another embodiment of the present invention, an information management system is enabled to analyze recorded video information and extract still frame photographs that may be used to issue citations based on the content of such photographs.

The present invention discloses a method whereby an information management system may be used to automatically create reports, graphs, and transaction logs documenting the historical use of a digital recording device. The information management system disclosed uses event transaction logs that are uploaded from the digital recording device during docking with the information management system in order to create useful reports and graphs.

Several advantages of the present invention include: (1) the ability to effectively manage digital information retained in digital recording devices and digital collection devices; (2) the storage and retention of digital information using criteria provided by an end-user; (3) the automated management of digital recording and collection devices; and (4) the ability to automate the process by which digital information is transferred from a digital recording device or digital collection device and an information management system.

### BRIEF DESCRIPTION OF THE DRAWINGS

The invention is better understood by reading the following detailed description of an exemplary embodiment in conjunction with the accompanying drawings, wherein:

FIG. 1 illustrates a block diagram of a conventional vehicle video and audio recording system;

FIG. 2 illustrates a block diagram of a digital video and audio recording system in accordance with an exemplary embodiment of the invention;

FIG. 3 illustrates a process for classifying information, uploading such information to an information management, and managing the storage, classification, and retention of such information in accordance with an exemplary embodiment of the invention;

FIG. 4 illustrates a block diagram of a prior art video/audio recording system and a prior art process for recording event information and managing the retention of such information;

FIG. 5 illustrates a block diagram of a digital recording system in accordance with an exemplary embodiment of the invention;

FIG. 5A illustrates a block diagram of an information management system in accordance with an exemplary embodiment of the invention;

FIG. 6 illustrates a table of digital information recorded by a digital collection (recorder) device in accordance with an exemplary embodiment of the invention;

FIG. 7 illustrates a process for automatically configuring a digital collection (recorder) device, synchronizing recorded information, and transferring such information to an information management system in accordance with an exemplary embodiment of the invention;

FIG. 8 illustrates a checkout process for checking in and checking out a digital recording device for use in conjunction with an information management system; and

FIG. 9 illustrates a process for managing licenses associated with a digital recording device in connection with an information management system.

### DETAILED DESCRIPTION OF THE INVENTION

The following description of the present invention is provided as an enabling teaching of the invention in its best, currently known embodiment. Those skilled in the relevant art will recognize that many changes can be made to the embodiment described, while still obtaining the beneficial results of the present invention. It will also be apparent that some of the desired benefits of the present invention can be obtained by selecting some of the features of the present invention without using other features. Accordingly, those who work in the art will recognize that many modifications and adaptations to the present invention are possible and may even be desirable in certain circumstances, and are a part of the present invention. Thus, the following description is provided as illustrative of the principles of the present invention and not in limitation thereof, since the scope of the present invention is defined by the claims.

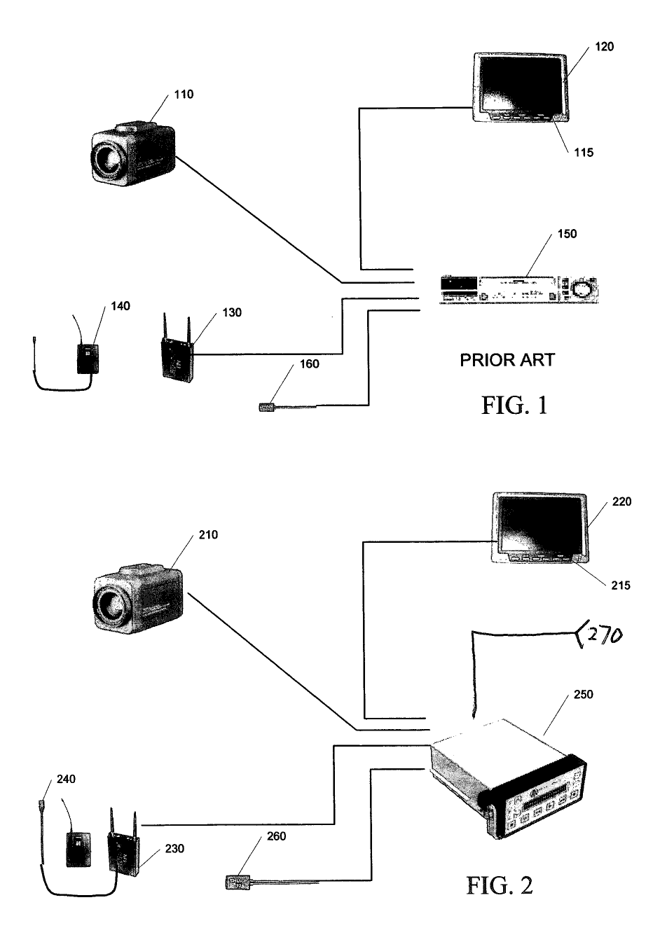

FIG. 1 is an example of a conventional system that records video and audio information on a magnetic tape, and that employs multiple components that are located within a vehicle. The system includes an analog magnetic media recorder 150, a video monitor 120, a camera 110, a speaker 115, a wireless radio receiver 130, an audio microphone 160, and a wireless audio microphone 140. The analog recorder 150 is frequently located in the trunk of a vehicle due to space or environmental constraints, the video monitor 120, the camera 110, the audio microphone 160, and the wireless radio receiver 130 are all typically located within the passenger compartment of a vehicle, and the audio microphone 140 is typically carried on the person of the end-user operator. Such a system requires installation of cables to multiple locations within a vehicle that may include the vehicle trunk, under the vehicle seat or other vehicle locations. The current system employs magnetic recording medium (typically magnetic tape cartridges in the VHS format) to record captured event information, and to allow transfer of such information to a non-mobile location such as a police station. The classification, storage, and retention of such magnetic recording media (magnetic tape cartridge) typically consists of certain data being logged into a database and an identification number being assigned to the tape. Such logged data may include the date the tape was recorded, a summary of the events recorded, the identification of the vehicle in which it was recorded, the law enforcement officer that had responsibility for the recording of the tape, the location in which the tape is to be stored for retention and retrieval purposes, and a date for the re-recording or destruction of the tape for archival purposes. When a specific event needs to be retrieved, the magnetic tape is retrieved from storage, placed in a playback device such as a typical VCR, and the tape is rewound or cued to the position that coincides with the start of the event. A dubbed copy may then be made by utilizing a second VCR that is connected to the first playback VCR. The ability to quickly and accurately retrieve the proper tape, find the desired event, and create a usable copy of the desired event can be cumbersome and slow.

FIG. 2 illustrates an example of a digital collection (recording) device that is the primary element that records and collects information that is subsequently transferred to an information management system. As shown in FIG. 2, the digital collection (recording) device 250 is enabled to receive information from multiple input sources such as a camera 210, a speaker 215, a wireless radio receiver 230, an audio microphone 260, a wireless audio microphone 240, and other digital information from sources such as a computer, a Global Positioning System (GPS) sensor, a GPS, a keypad, a radar gun, and the like, and that are each connected to an input bus 270. A video monitor 220 may also be attached to the digital collection device 250 to allow an end-user operator to monitor the various input sources. As shown in FIG. 2, the digital information is recorded directly to a digital recording medium such as a computer hard disk drive, a computer memory device, or the like, and therefore does not require the use of magnetic tapes. Each event is recorded onto the digital recording medium as a separate file. Utilizing this methodology allows the recorded file to be copied or deleted in a manner similar to a conventional computer data file, thereby eliminating the need to manage the classification, storage and retention of magnetic tapes. The digital collection device 250 is installed within a vehicle passenger compartment and is advantageously removable by the end-user operator to facilitate the transfer of the recorded information to an information management system.

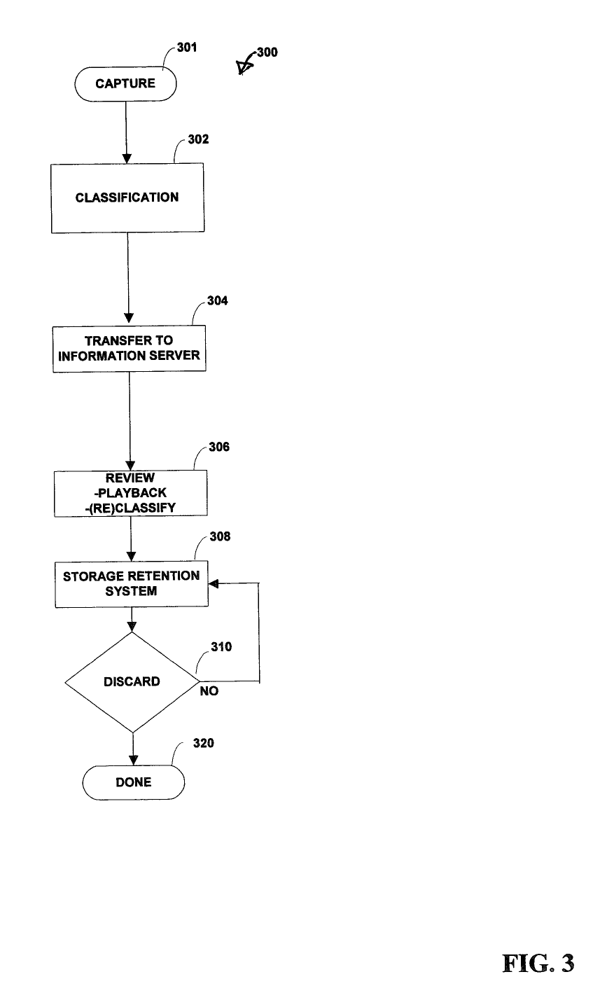

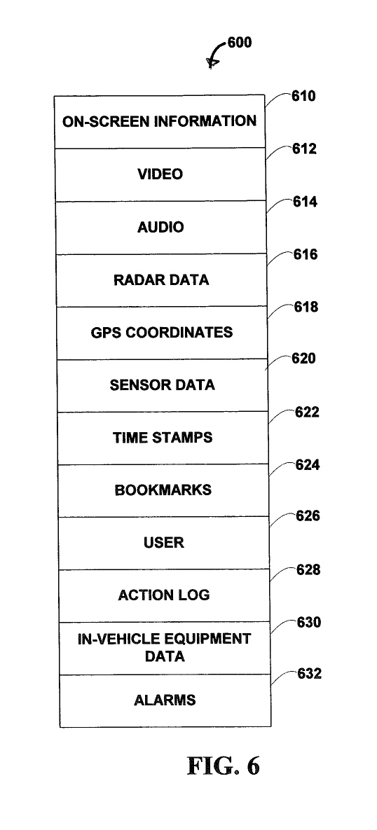

FIG. 3 illustrates a process for classifying information, uploading such information to an information management, and managing the storage, classification, and retention of such information, and further illustrates the flow of recorded information through its lifecycle. The process begins at step 301 whereby an event is recorded, and data is captured, by a digital collection device. At step 302, certain attributes are associated with the information collected at step 301 that may be advantageously used to store, manage, distribute, and retain such information. Examples of such attributes may include without limitation a unique file identification number, the date and time the event was recorded, the geographic coordinates associated with each frame of information recorded, an identification number associated with the digital collection device itself, an identification number of the vehicle in which it was recorded, the name and badge number of the law enforcement officer that had responsibility for making the recording, and a summary of the event recorded (e.g. routine traffic stop, public safety “10” code, and the like). A further illustration of the use of such attributes allows such attributes to be associated with the information collected at step 301 individually or collectively, and thereby searched and categorized accordingly. For example, an assault on a police officer may correspond to a unique classification code (ex. #5, or AS, etc.). Classification may be employed as both a single attribution, or multiple character and multiple levels of attribution, such as a “Police Assault” by a “White” “Male” citizen. Each of these three attributes may be associated with the recorded event for further processing by an information management system. Further examples of types of such attributes are further illustrated in FIG. 6. At step 304, the information is transferred from a digital collection device to an information management system for further processing, storage, and future retrieval. At step 306, the recorded event information may be reviewed to ensure that the attributes associated with the recorded event are accurate. Certain attributes that comprise facts, such as the date and time the event was recorded, the identification number of the digital collection device, and the like, may be hard-coded and therefore non-editable to ensure the integrity of the information recorded and its subsequent use for court proceedings. Examples of attributes that may be changed include categorizing the video information captured, such as the gender and race of the persons in the recorded video images, the nature of the “10” codes, and the like. Proceeding to step 308, the event information is further processed by associating certain additional attributes with the information that may be used for storage and retrieval purposes. For example, the information management system may automatically assign a backup date, a backup location, a deletion date, and the like. Proceeding to step 310, each file stored in the information management system may be periodically reviewed to determine if further processing based on the associated attributes is required, such as further backup or deletion. The system continuously loops back to step 308 to continue such automated processing. If the information management system determines that a file should be deleted based on such associated attributes, the process proceeds to step 320 and the process ends.

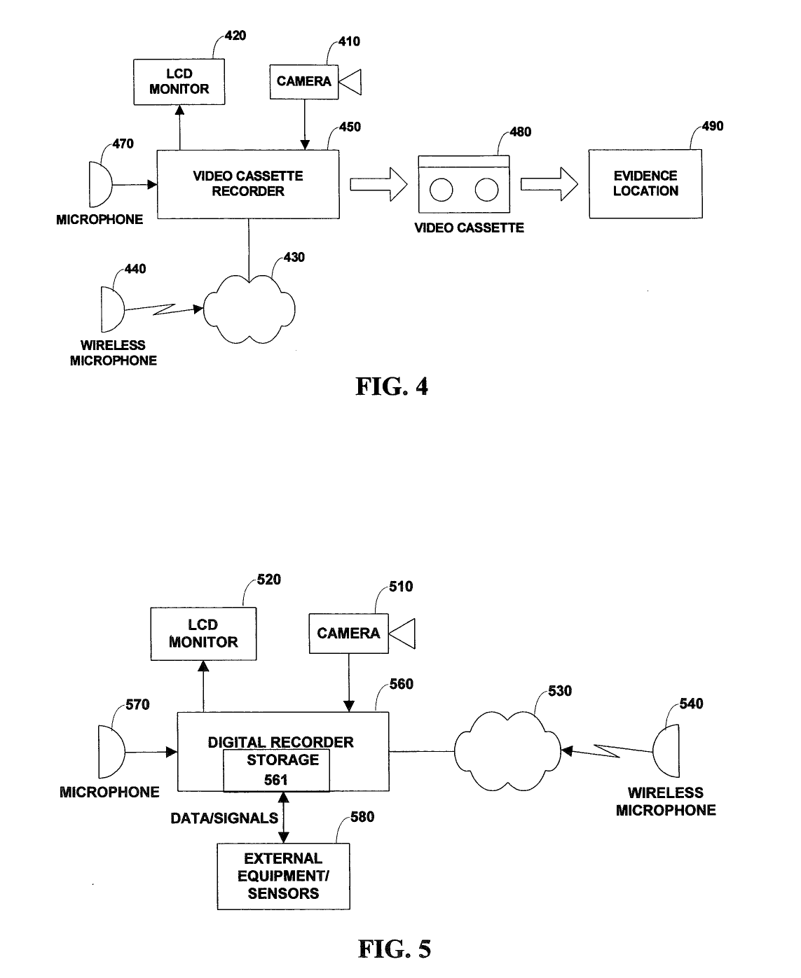

FIG. 4 illustrates a block diagram of a prior art video/audio recording system and a prior art process for recording event information and managing the retention of such information. As shown in FIG. 2, this prior art system comprises a VCR 450 that records video and audio information to a removable video cassette tape 480, a camera 410, a display 420, a microphone 470, a wireless radio transceiver 430, and a wireless microphone 440 suitably enabled to communicate with wireless transceiver 430. In order to use the information recorded by the illustrated system on video cassette tape 480, the tape must be removed from VCR 450 and taken to another location for further processing. The information stored on cassette tape 480 may be further reviewed for evidentiary purposes, and then stored in a secure location such as an evidence room 490. Any processing or further categorization of the information stored on cassette tape 480 must be performed manually and requires obtaining physical access to cassette tape 480.

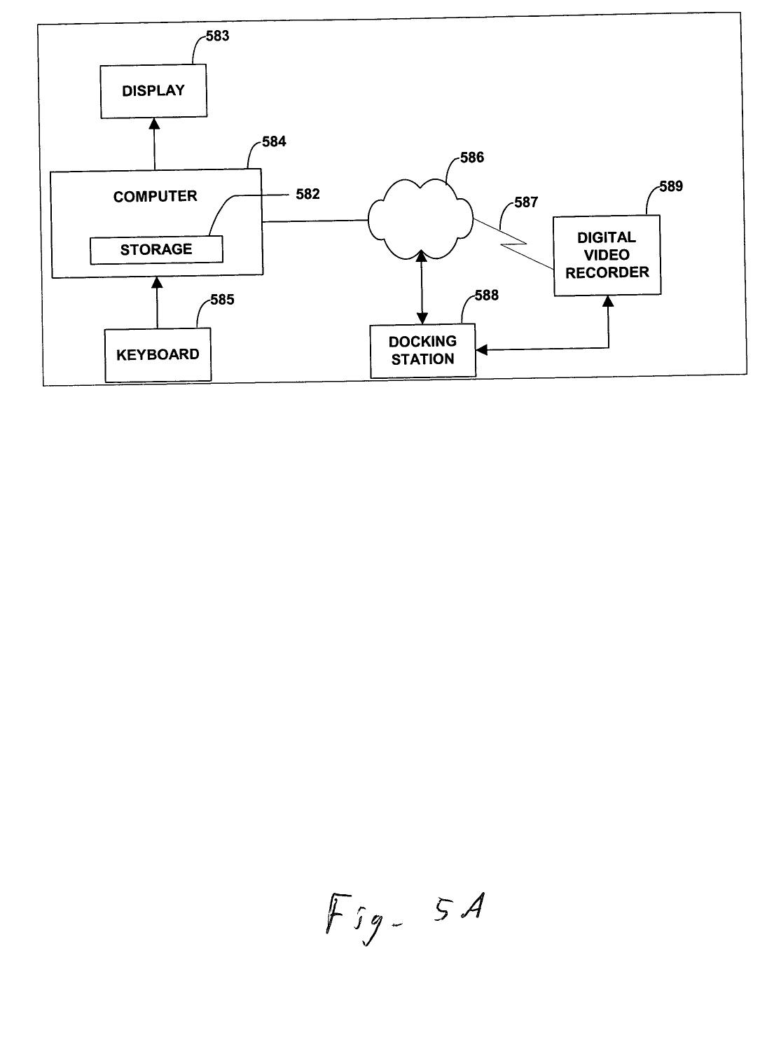

FIG. 5 illustrates a block diagram of a digital recording system. As shown in FIG. 5, this system comprises a digital recording device 560 that records video and audio information as well as other digital information to an internal storage medium 561, a camera 510, a display 520, a microphone 570, a wireless radio transceiver 530, a wireless microphone 540 suitably enabled to communicate with wireless transceiver 530, and one or more external digital signal sources 580. Examples of such signal sources 580 include without limitation an in-vehicle crash sensor, an airbag deployment sensor, a door-open indicator, an on-board vehicle computer system, one or more mobile data terminals, and the like. Certain examples of external digital signal sources may also be enabled to communicate with digital recording device 560 via wireless transceiver 530. Internal storage medium 561 may be a computer hard disk drive, flash memory chips, or other similar digital storage devices. In one embodiment of the present invention, the information stored on internal storage medium 561 may be transferred to an information management system via wireless transceiver 530. In another embodiment of the present invention, the information stored on internal storage medium 561 may be transferred to an information management system by removing digital recording device 560 from the vehicle where the information was recorded and inserting it into a docking station electrically attached to the information management system and downloading such information thereto. Methods for storing, retaining, reviewing, and further processing of such information are disclosed herein.

FIG. 5A illustrates a block diagram of an information management system. As shown in FIG. 5A, this system comprises a computer 584 that executes software applications used to manage the transfer, storage, and retrieval of video and audio information as well as other digital information to an internal storage medium 582, a display 583, a keyboard 585, a connection to a communications network 586, a wireless communications link 587 suitably enabled to communicate with digital recording devices such as the digital recording device 589, and a docking station 588 suitably enabled to dock one or more digital recording devices. In one embodiment of the present invention, information is uploaded from one or more digital recording devices when such devices are docked in docking station 588 to internal storage medium 582. In another embodiment of the present invention, information is uploaded from one or more digital recording devices to internal storage medium 582 via wireless communications link 587. Methods for storing, retaining, reviewing, and further processing of such information are disclosed herein.

FIG. 6 illustrates a table of digital information recorded by a digital collection (recorder) device. In addition to audio information 614 and video information 612, the digital recording device is suitably enabled to record other information such as on-screen text information 610 that is overlaid on the video information stream and includes without limitation such information such as the name of the end-user operator, the date and time of day, and the speed of the vehicle in which the digital collection (recorder) device is mounted, radar data 616 from a traffic radar gun that may include the detected speed output of a target vehicle and the vehicle in which such radar gun is mounted, GPS coordinates 618 received from a GPS sensor, time stamp information 622 that memorializes the time that each event was recorded, bookmarks 624 that may be manually or automatically added to the recorded information and that would be used to quickly navigate to recorded events of particular interest, user information 626 that identifies the end-user operator of a digital recording device, action log information 628 that includes without limitation such information as the time the recorder was activated, the means by which the recorder was activated, and the length of the recorded information file, in-vehicle equipment data 630 such as data available from a Controller Area Network or other vehicle systems, and alarm information 632 such as the status of a vehicle's siren, its warning lights, and other alert-type information. All of the information sources noted may be stored together is a single file, or the information may be stored in a database as individual files by data type, or in a similar fashion. This information can then be downloaded to, and processed by, an information management system by the methods disclosed herein.

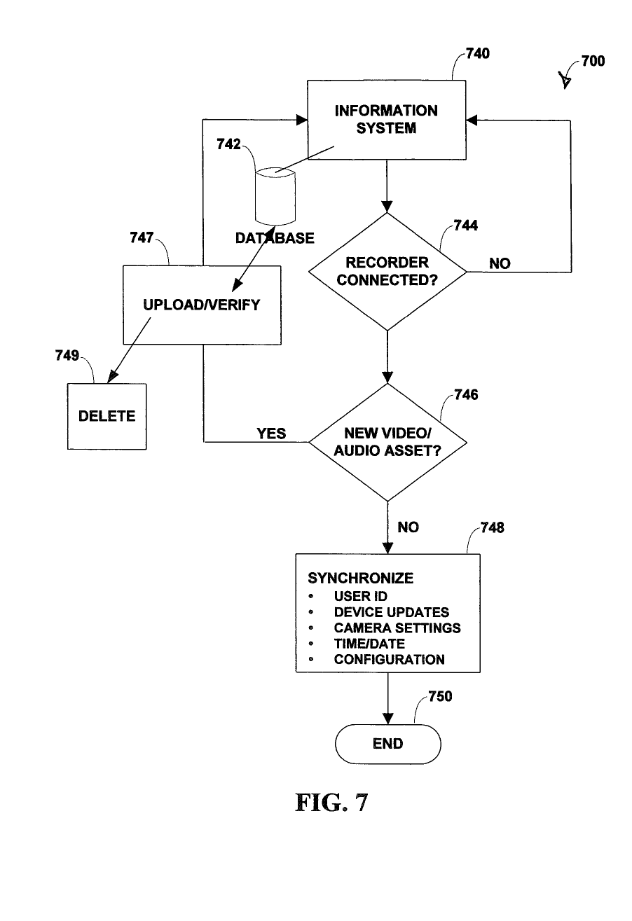

FIG. 7 illustrates a flow diagram of an automated process used to identify and synchronize newly created digital information, and to transfer the files containing such digital information from a digital recording device to an information management system via an automated method. In one embodiment of the present invention, an end-user operator would periodically remove a digital recording device from its docking station in a vehicle, such as at the end of a patrol shift. The end-user operator would carry the digital recording device to a central docking station attached to an information management system in order to upload the information recorded and to prepare the digital recording device for use by another end-user operator, or for use on the next patrol shift, or the like. After the information has been successfully transferred to an information management system and stored in a database, the data may then be processed. The process begins at step 740 where an information management system is initialized to determine if a digital recording device has been docked with the information management system. At step 744, the information management system determines whether a digital recording device is presently docked to the information management system. If not, the process loops back to step 740. If the information management system determines that a digital recording device is presently docked to the information management system, the process proceeds to step 746. At step 746, the process determines whether a given information file has been previously transferred to the information management system. If such information file is determined to be new, the information file is uploaded to the information management system, and the information management system verifies at step 747 that the information was properly received and stored on a database at step 742. This process repeats until all new information files have been uploaded, and then the uploaded information files are deleted from the memory of the digital recording device. Once all new information files have been uploaded, the process proceeds to step 748. At step 748, the digital recording device is prepared to be returned to service, such as when the end-user operator needs a refreshed digital recording device in order to begin another patrol shift. Continuing at step 748, the information management system verifies that the internal memory of the digital recording device is reset, that the user identification information has been reset for the next end-user operator, that any end-user preferences have been loaded (based on an end-user operator profile that is stored on a database connected to the information management system), that the date and time are properly calibrated, and the like. The information management system may also be suitably enabled to update the read-only memory or BIOS of the digital recording device with the latest versions of any firmware software code. The information management system then confirms that the digital recording device is ready to return to service, and the process ends at step 750.

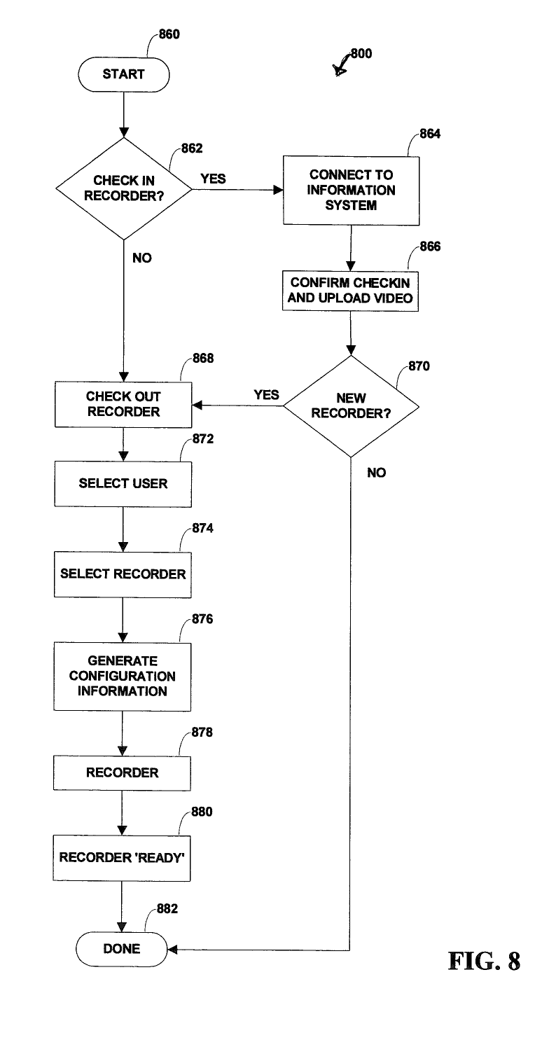

FIG. 8 illustrates a flow diagram of an automated process for checking in and checking out a digital collection (recorder) device. The present invention is suitably enabled to allow multiple end-user operators to use multiple digital recording devices. In order to do so, it is necessary to provide a process that enables the information management system to track the status of each digital recording device that is enabled to connect to the information management system. The process depicted in FIG. 8 is suitably enabled for an information management system that has multiple docking stations attached allowing the information management system to control multiple digital recording devices. The process begins at step 860 and proceeds to step 862 where the information management system determines whether an end-user operator desires to check-in or check-out a digital recording device. If the end-user operator desires to check-in a digital recording device, the device is inserted into a docking station attached to the information management system and the process proceeds to step 864 where the information management system prepares to upload the information stored in the internal memory of a digital recording device to the information management system. At step 866, the information management system prompts the end-user operator to confirm his intent to check-in the digital recording device and upload the stored information. If confirmed, the data is uploaded, and the digital recording device is made available for subsequent check-out by an end-user operator. The process then proceeds to step 870 where it is determined if the end-user operator desires to check-out another digital recording device. If so, the process proceeds to step 868. If the end-user operator does not desire to check-out another digital recording device, the process ends. If a digital recording device is not being checked-in at step 862, the process proceeds to step 868 where the digital recording device is made available to be checked-out. The process then proceeds to step 872, where the end-user operator selects his user profile from a menu, and the process proceeds to step 874 where the end-user operator selects one of the available digital recording devices attached to or controlled by the information management system. At step 876 the end-user operator's user profile is either retrieved from the information management system and confirmed by the end-user operator, or the end-user operator is prompted for required information in order for the information management system to create a new user profile. If the user profile is confirmed by the end-user operator, the process proceeds to step 878 where the selected user profile is downloaded to the selected digital recording device. The process then proceeds to step 880 where the end-user operator is prompted to remove the now-checked-out digital recording device from its docking station, the process proceeds to step 882 and the process ends.

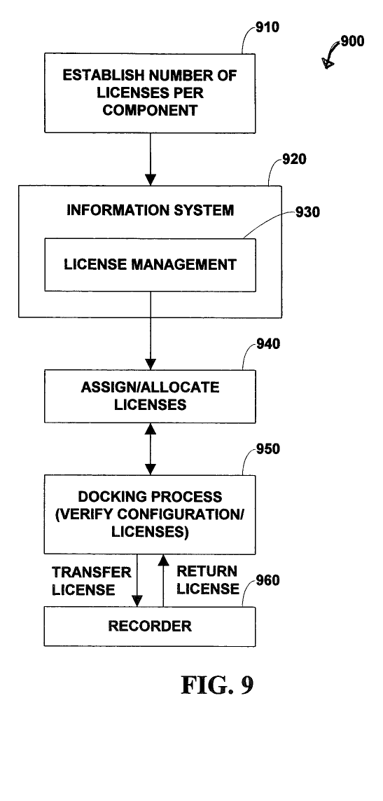

FIG. 9 illustrates a flow diagram of an automated process for managing licenses for optional features available for use in connection with a digital recording device. The present invention contemplates that it is possible that a law enforcement agency may purchase a large number of digital recording devices, but that certain features may not be enabled in each digital recording device. For example, a digital recording device may be carried in each vehicle operated by such a law enforcement agency, but only a subset of such vehicles are routinely used to patrol for speeding motorists. Therefore, such a law enforcement agency may opt to minimize its software license fees by procuring licenses that enable the digital recording device to communicate with a radar gun for only a subset of its digital recording devices. In the event that a given digital recording device does not contain a license for such a feature, or that the license is not enabled, the information management system can assign a “floating” license to such a digital recording device, activate an existing license, or procure additional licenses in real time. This method can be used to prevent the unauthorized use of licensed features and to maximize license revenue for the supplier of the digital recording devices. The process begins at step 910 where the information management system determines the number of licenses for each licensed component that are available and presently enabled in one or more digital recording devices. At step 920, an end-user operator can assign an available license to a given digital recording device. At step 930, the information management system determines if a given digital recording device is enabled for licensed features in excess of allowed, or purchased, available licenses. If so, the information management system can disable the feature, or electronically procure an additional license from the software vendor. At step 940, an end-user operator can allocate available licenses to one or more digital recording devices that are presently docked and attached to an information management system. At step 950, the information management system will verify the status of the licenses assigned to each of the docked digital recording devices. If a given digital recording device is configured to receive a license, such license is then enabled. If a given digital recording device is not configured to receive a license, and such license was previously enabled, then such license is disabled. At step 960, the process may transfer, re-assign, or order additional licenses to meet the needs of the information management system to provide appropriate licenses to each of the docked digital recording devices. The information management system is therefore suitably enabled to manage a pool of available licensed among a number of digital recording devices.

While the invention has been particularly shown and described with reference to an exemplary embodiment thereof, it will be understood by those skilled in the art that various changes in form and detail may be made without departing from the spirit and scope of the invention.

1. An information management system comprising:
a computer;
a storage medium;
a keyboard;
a communications network; and
a docking station for docking a digital recording device.

2. The information management system of claim 1 wherein said docking station is enabled to simultaneously dock more than one digital recording device

3. The information management system of claim 1 further comprising means for managing, uploading, storing, retrieving, archiving, and downloading information from and to a digital recording device.

4. A method for synchronizing an information management system with a digital recording device, the method comprising the steps of:
docking a digital recording device in a docking station connected to said information management system;
reading a first clock signal stored in the memory of said digital recording device;
comparing said first clock signal of such digital recording device with a master clock signal stored in the memory of said information management system and determining the difference between said first clock signal and said master clock signal;
updating said first clock signal to be equal to said master clock signal and storing said updated clock signal in the memory of said digital recording device;
storing the difference between said first clock signal and said master clock signal, and the date and time such discrepancy was determined, in an error log in the memory of said information management system; and
storing the difference between said first clock signal and said master clock signal in an error log in the memory of said digital recording device.

5. A method for synchronizing an information management system with a digital recording device, the method comprising the steps of:
docking a digital recording device in a docking station connected to said information management system;
reading a first clock signal stored in the memory of said digital recording device;
comparing said first clock signal of such digital recording device with a master clock signal stored in the memory of said information management system and determining the difference between said first clock signal and said master clock signal;
downloading recorded information and said first clock signal stored in the memory of said digital recording device and storing such recorded information in the memory of said information management system; and
storing the difference between said first clock signal and said master clock signal with said downloaded information.

6. A method for classifying information recorded by a digital recording device, the method comprising the steps of:
docking a digital recording device in a docking station connected to an information management system;
uploading information recorded by said digital recording device and associated with an event to the memory of said information management system;
reviewing said uploaded information and associating additional attributes to such information based on said review to assist in subsequent reviews of such information; and
storing said information and said additional attributes in the memory of said information management system.

7. The method of claim 6 wherein said uploaded information is stored in a first computer file, said additional attributes are stored in a second computer file, and said first computer file and said second computer file are associated by relational means.

8. The method of claim 7 wherein said additional attributes comprise:
a date on which said first computer file must be backed-up for archival purposes;
a date on which said second computer file must be backed-up for archival purposes;
one or more locations where said first computer file and said second computer file are to be archived;
a date on which said first computer file and said second computer file should be reviewed to determine if further classification of said recorded events should be undertaken;
a list of users that have been granted permission to read and/or edit said first computer file and said second computer file; and
a date on which said first computer file and said second computer file should be deleted.

9. A method for transferring information recorded by a digital recording device to an information management system, the method comprising the steps of:
determining if a digital recording device is connected to said information management system;
reading a first computer file stored in the memory of said digital recording device;
determining whether said first computer file has been previously uploaded to said information management system by comparing said first computer file to a table of all computer files stored in the memory of said information management system;
uploading said first computer file from said digital recording device; and
verifying that said uploaded first computer file was properly uploaded and stored to the memory of said information management system.

10. The method of claim 9 further comprising the steps of:
reading subsequent computer files stored in the memory of said digital recording device;
determining whether said subsequent computer files have been previously uploaded to said information management system by comparing said subsequent computer files to a table of all computer files stored in the memory of said information management system;
uploading said subsequent computer files from said digital recording device;
verifying that said uploaded subsequent computer files were properly uploaded and stored to the memory of said information management system; and
deleting each uploaded and verified computer file from the memory of said digital recording device.

11. The method of claim 9 wherein said connection between said digital recording device and said information management system is accomplished by means of inserting said digital recording device in a docking station attached to said information management system.

12. The method of claim 9 wherein said connection between said digital recording device and said information management system is accomplished by means of said digital recording device communicating with said information management system via a wireless communications link.

13. A method for managing the assignment of a plurality of digital recording devices, the method comprising the steps of:
determining that one or more digital recording devices are docked in a docking station connected to an information management system;
determining that one or more of said digital recording devices have not been check-in by querying the memory of each of said digital recording devices;
uploading end-user-specific information from the memory of each of said digital recording devices that identifies the end-user operator that last checked-out each of said digital recording devices;
verifying said end-user operators' authority to check-in each of said digital recording devices;
uploading information associated with one or more recorded events to the memory of said information management system;
deleting said uploaded event information from the memory of each of said digital recording devices; and
deleting said end-user-specific information from the memory of each of said digital recording devices, thereby enabling each of said digital recording devices to be checked-out by another end-user operator.

14. A method for managing the assignment of a plurality of digital recording devices, the method comprising the steps of:
determining that one or more digital recording devices are docked in a docking station connected to an information management system;
selecting a user-specific profile containing preferences associated with a given end-user operator;
downloading such user-specific profile information to one of said digital recording devices; and
commanding the information management system to release said digital recording device from said docking station by enabling the operation of said selected digital recording device; and

15. A method for managing the assignment of a plurality of digital recording devices, the method comprising the steps of:
determining that one or more digital recording devices are docked in a docking station connected to an information management system;
prompting an end-user operator to select a user-specific profile containing preferences selected by such end-user operator to customize the operation of a digital recording device, said user-specific profile being stored in the memory of said information management system, and further prompting said end-user operator to select a desired digital recording device;
prompting said end-user operator to for a password thereby authorizing said information management system to download a user-specific profile containing preferences selected by such end-user operator to said selected digital recording device;
downloading such user-specific profile information to said digital recording device and confirming that said digital recording device is ready to be checked-out;
commanding the information management system to release said selected digital recording device from said docking station by enabling the operation of said selected digital recording device; and
prompting said end-user operator to remove the selected digital recording device from said docking station.

16. The method of claim 14 further comprising the step of disabling the operation of a docked digital recording device in the event that such docked digital recording device is removed from said docking station prior to being released by said information management system.

17. A method for managing a pool of software licenses, the method comprising the steps of:
establishing a pool of licenses by determining the total number of software licenses that are authorized for each of a plurality of software features;
determining an available pool of unassigned licenses by determining the number of such software licenses that are presently assigned to one or more digital recording devices that have been checked-out by an information management system; and
reserving one or more software licenses corresponding to the features embodied in a selected user-profile.

18. The method of claim 17, further comprising the steps of:
prompting an end-user operator to confirm that such end-user operator desires to check-out a selected digital recording device docked in a docking station connected to an information management system, thereby claiming said reserved software licenses associated with features embodied in a selected user-profile; and
downloading said licenses to said selected digital recording device, thereby enabling the features that correspond to such software licenses.

19. The method of claim 17, further comprising the steps of:
determining that the pool of available licenses is inadequate to meet the requirements of a selected user-profile; and
obtaining additional licenses from a software licensor in order to satisfy the requirements of said selected user-profile.

20. The method of claim 19 wherein said additional licenses are automatically obtained from said software licensor electronically.

21. The method of claim 19 wherein said additional licenses are automatically obtained from said software licensor via the internet

22. The method of claim 18, further comprising the steps of:
determining that the pool of available licenses is inadequate to meet the requirements of a selected user-profile;
disabling software features that were previously enabled in one or more digital recording devices that are presently docked in a docking station connected to an information management system, thereby returning previously assigned but unused software licenses to said pool of available licenses; and
downloading said licenses to said selected digital recording device, thereby enabling the features that correspond to such software licenses.

23. A method for transferring information recorded by a digital recording device to an information management system, the method comprising the steps of:
determining if a digital recording device is connected to said information management system;
determining if a request from an end-user for a given recorded event has been stored in the memory of an information management system;
querying the memory of said digital recording device to determine if a computer file corresponding to such requested recorded event is stored in reading a first computer file stored in the memory of said digital recording device;
uploading said computer file corresponding to such requested recorded event from said digital recording device; and
electronically delivering said computer file to said end-user.

24. A method for transferring information recorded by a digital recording device to an information management system based on a set of rules, the method comprising the steps of:
determining if a digital recording device is connected to said information management system;
reading a set of rules into the memory of said information management system;
querying the memory of said digital recording device to determine if one or more such rules may be satisfied by uploading certain information stored in the memory of said digital recording device; and
uploading one or more computer files stored in the memory of said digital recording device that would satisfy each of said rules.

25. A method for transferring information recorded by a digital recording device to an information management system based on a priority embodied in a set of rules, the method comprising the steps of:
determining if a digital recording device is connected to said information management system;
reading a set of rules into the memory of said information management system;
querying the memory of said digital recording device to determine if one or more such rules may be satisfied by uploading certain information stored in the memory of said digital recording device; and
uploading one or more computer files stored in the memory of said digital recording device in prioritized order that would satisfy each of said rules.

26. A method for monitoring the status of software and firmware of a digital recording device, the method comprising the steps of:
determining if a digital recording device is connected to said information management system;
querying the memory of said digital recording device to determine the version and release level of one or more software components;
comparing said version and release levels of such software to a master reference list stored in the memory of said information management system; and
replacing down-level versions of said software components by downloading more resent versions of said software components to the memory of said digital recording device.
